(19) United States
(12) Patent Application Publication
(10) Pub. No.: US 2020/0016757 A1
(43) Pub. Date: Jan. 16, 2020

(54) ROBOT CONTROL APPARATUS AND CALIBRATION METHOD

(71) Applicant: Mitsubishi Electric Corporation, Tokyo (JP)

(72) Inventor: Yasunori SAKURAMOTO, Tokyo (JP)

(73) Assignee: Mitsubishi Electric Corporation, Tokyo (JP)

(21) Appl. No.: 16/347,196

(22) PCT Filed: Jun. 8, 2017
(86) PCT No.: PCT/JP2017/021349

§ 371 Date: May 2, 2019

(30) Foreign Application Priority Data
Mar. 9, 2017 (JP) 2017-045267

(51) Int. Cl. B25J 9/16; B25J 13/08; B25J 9/10; B25J 19/04

(52) U.S. Cl. CPC B25J 9/1692; B25J 13/08; B25J 9/1697; B25J 19/04; B25J 9/10

(57) ABSTRACT

A robot control apparatus includes: a robot control unit to control operation of a robot using calibration data; an image processing unit to acquire camera coordinates of a reference marker from image data acquired by a vision sensor; an error calculating unit to calculate an error on a basis of a difference between camera coordinates of the reference marker corresponding to the calibration data and current camera coordinates of the reference marker; a calibration-data calculating unit to calculate new calibration data when an absolute value of the error becomes greater than a threshold; and a calibration-data storing unit to register the new calibration data. The robot control apparatus causes the calibration-data calculating unit to calculate the new calibration data a plurality of times while causing the robot to operate between the calculations and causes the calibration-data storing unit to register a plurality of pieces of calibration data.

### FIELD

The present invention relates to a robot control apparatus that controls a robot and to a calibration method in the robot control apparatus.

### BACKGROUND

A method for correcting a mechanism error in order to improve the accuracy of the absolute position of a robot is proposed, for example, in Patent Literature 1. In Patent Literature 1, an operation area of a robot is divided into small areas, a mechanism error of the robot is calculated for each of the small areas, an error analytical formula that reduces the error is determined, and the mechanism error is corrected using the analytical formula.

### CITATION LIST

### Patent Literature

Patent Literature 1: Japanese Patent Application Laid-open No. H07-200017

### SUMMARY

### Technical Problem

In the conventional technique in Patent Literature 1, an error analytical formula that reduces an error is determined for each of the small areas into which an area is divided, and thus a mechanism error in an operation space can be reduced. However, it is not ensured that a mechanism error due to a change over time, such as thermal drift when a robot is operated for a long time, is reduced. Thus, there is a problem in that the accuracy of the absolute position of the robot is reduced as the robot is operated for a long time.

The present invention has been made in view of the above problem, and an object thereof is to provide a robot control apparatus capable of improving the accuracy of an operation position of a robot in an environment in which a mechanism error over time occurs in the robot.

### Solution to Problem

In order to solve the above problem and to achieve the object, an aspect of the present invention includes: a robot control unit to control operation of a robot using calibration data; an image processing unit to acquire camera coordinates of a reference marker from image data acquired by a vision sensor; an error calculating unit to calculate an error on a basis of a difference between camera coordinates of the reference marker corresponding to the calibration data and current camera coordinates of the reference marker; a calibration-data calculating unit to calculate new calibration data when an absolute value of the error becomes greater than a threshold; and a calibration-data storing unit to register the new calibration data. In an aspect of the present invention, the robot control apparatus causes the calibration-data calculating unit to calculate the new calibration data a plurality of times while causing the robot to operate between the calculations and causes the calibration-data storing unit to register a plurality of pieces of calibration data.

### Advantageous Effects of Invention

According to the present invention, an effect is obtained where it is possible to obtain a robot control apparatus capable of improving the accuracy of an operation position of a robot in an environment in which a mechanism error over time occurs in the robot.

### BRIEF DESCRIPTION OF DRAWINGS

FIG. 1 is a diagram illustrating an example configuration of a robot control system according to a first embodiment of the present invention.

FIG. 2 is a perspective view illustrating a robot, a vision sensor, and a reference marker according to the first embodiment.

FIG. 3 is a diagram illustrating a hardware configuration when functions of a robot control apparatus according to the first embodiment are implemented by a computer.

FIG. 4 is a flowchart for explaining pre-registration of calibration data according to the first embodiment.

FIG. 5 is a diagram for explaining a relation between an error in camera coordinates and an error in robot coordinates in the first embodiment.

FIG. 6 is a perspective view illustrating another configuration including the robot, the vision sensor, and the reference marker according to the first embodiment.

FIG. 7 is a view illustrating an imaging screen displaying the reference marker using a fixing method according to the first embodiment.

FIG. 8 is another view illustrating the imaging screen displaying the reference marker using the fixing method according to the first embodiment.

FIG. 9 is a diagram illustrating a configuration of a robot control apparatus according to a second embodiment of the present invention.

FIG. 10 is a flowchart at the time of actual operation of a robot control system using calibration data according to the second embodiment.

FIG. 11 is a diagram for explaining temporal variation in errors in the second embodiment.

### DESCRIPTION OF EMBODIMENTS

Hereinafter, a robot control apparatus and a calibration method according to embodiments of the present invention are described in detail with reference to the drawings. Note that, the invention is not limited by the embodiments.

### First Embodiment

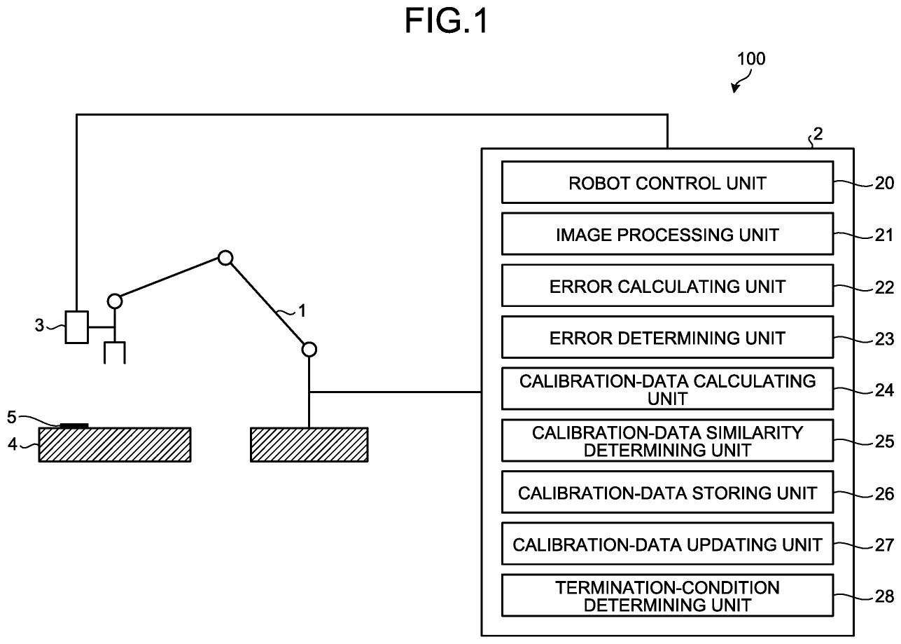

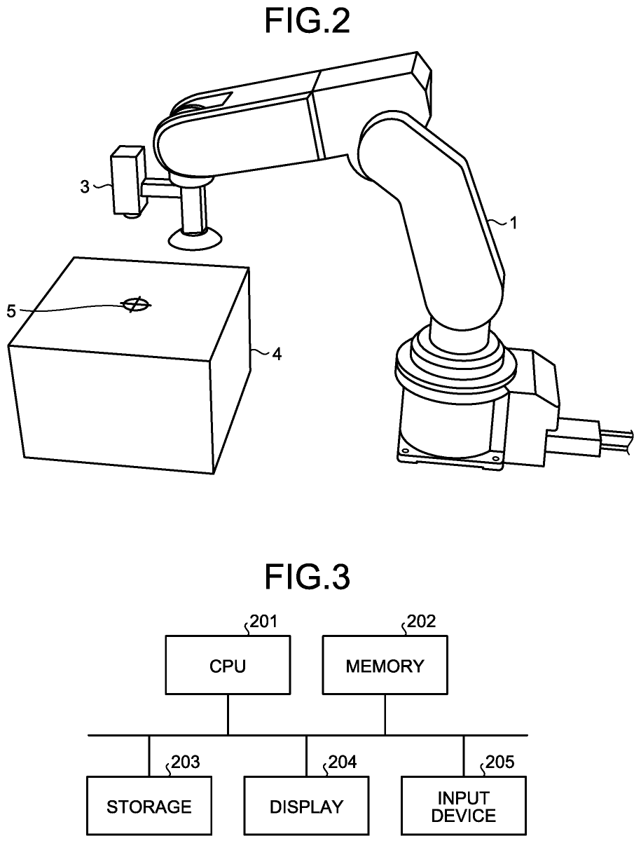

FIG. 1 is a diagram illustrating an example configuration of a robot control system 100 according to a first embodiment of the present invention. FIG. 2 is a perspective view illustrating a robot 1, a vision sensor 3, and a reference marker 5 according to the first embodiment. FIGS. 1 and 2 each illustrate an example of a hand-eye method in which the vision sensor 3 is attached to the hand of the robot 1.

As illustrated in FIG. 1, the robot control system 100 includes a robot 1; a robot control apparatus 2 that controls the robot 1; a vision sensor 3 attached to the hand of the robot 1; a workbench 4; and a reference marker 5 installed within the operation range of the robot 1 on the workbench 4. A specific example of the vision sensor 3 is a camera.

The robot control apparatus 2 includes a robot control unit 20, an image processing unit 21, an error calculating unit 22, and an error determining unit 23. The robot control unit 20 issues a command to the robot 1 using calibration data to control the operation of the robot 1. The image processing unit 21 processes image data acquired by the vision sensor 3. The error calculating unit 22 calculates a control position error of the robot 1. The error determining unit 23 determines the calculated error. The calibration data is a parameter for performing conversion between a robot coordinate system, which is the coordinate system of the robot 1, and a camera coordinate system, which is the coordinate system of the vision sensor 3, i.e., calibration.

The robot control apparatus 2 further includes a calibration-data calculating unit 24, a calibration-data similarity determining unit 25, a calibration-data storing unit 26, a calibration-data updating unit 27, and a termination-condition determining unit 28. The calibration-data calculating unit 24 calculates calibration data. The calibration-data similarity determining unit 25 determines the similarity between calculated calibration data and registered calibration data. The calibration-data storing unit 26 registers calibration data. The calibration-data updating unit 27 updates calibration data to be used by the robot control unit 20. The termination-condition determining unit 28 determines whether to repeat calculation of calibration data.

The robot control apparatus 2 has an automatic calibration function for automatically calculating calibration data. The automatic calibration is to move the hand of the robot 1 to which the vision sensor 3 is attached in directions, for example, back and forth and side to side, to image and recognize the reference marker 5 from a plurality of viewpoints, and to acquire a correspondence relation between the camera coordinates of the reference marker 5 and the robot coordinates of the robot 1 in order to calculate calibration data. Here, the camera coordinates of the reference marker 5 are the coordinates of the reference marker 5 in the camera coordinate system within the imaging screen of the vision sensor 3. In the following descriptions, the camera coordinate system has two dimensions as an example; however, the camera coordinate system is not limited to having two dimensions and may have three dimensions. The robot coordinates of the robot 1 are, in the space in which the robot 1 is placed, three-dimensional coordinates of the hand of the robot 1 to which the vision sensor 3 is attached.

In the automatic calibration of the robot control apparatus 2, first, the hand of the robot 1 to which the vision sensor 3 is attached is moved in directions, for example, back and forth and side to side, on the basis of a command from the robot control unit 20, and the reference marker 5 is imaged from a plurality of viewpoints by the vision sensor 3 to acquire image data. The image processing unit 21 recognizes the reference marker 5 from the acquired image data at the multiple viewpoints and obtains the respective camera coordinates of the reference marker 5. Because the robot control unit 20 obtains the respective robot coordinates of the robot 1 in the robot coordinate system when the reference marker 5 is imaged by the vision sensor 3 from the multiple viewpoints, the same number of combinations of camera coordinates and robot coordinates as the number of viewpoints can be acquired. From the correspondence relation between the camera coordinates and the robot coordinates at one viewpoint, one formula in which each parameter of calibration data is an unknown is obtained. Thus, three or more formulae can be obtained by acquiring combinations of camera coordinates and robot coordinates at three or more viewpoints. Then, the calibration-data calculating unit 24 can calculate calibration data by simultaneously solving the obtained three or more formulae. The automatic calibration is to calculate calibration data in this manner.

FIG. 3 is a diagram illustrating a hardware configuration when functions of the robot control apparatus 2 according to the first embodiment are implemented by a computer. When functions of the robot control apparatus 2 are implemented by a computer, the functions of the robot control apparatus 2 are implemented by a central processing unit (CPU) 201, a memory 202, a storage 203, a display 204, and an input device 205 as illustrated in FIG. 3. The function of the calibration-data storing unit 26 of the robot control apparatus 2 is implemented by the storage 203, but the other functions of the robot control apparatus 2 are implemented by software, such as an operation program of the robot 1. The software is described as a program and stored in the storage 203. The CPU 201 loads, in the memory 202, the operation program stored in the storage 203 and controls the operation of the robot 1. In addition, the CPU 201 performs a calibration method, which is to be described below, in the robot control apparatus 2 according to the first embodiment in this manner. That is, the operation program causes the computer to perform the calibration method according to the first embodiment. This means that the robot control apparatus 2 includes the storage 203 for storing the operation program which will eventually execute the steps of performing the calibration method according to the first embodiment. The memory 202 is, for example, a volatile storage area, such as a random access memory (RAM). The storage 203 is, for example, a nonvolatile or volatile semiconductor, such as a read only memory (ROM), a flash memory, an erasable programmable read only memory (EPROM), or an electrically erasable programmable read only memory (EEPROM) (registered trademark), a magnetic disk, a flexible disk, an optical disk, a compact disk, a mini disk, or a digital versatile disk (DVD). Specific examples of the display 204 are a monitor and a display. Specific examples of the input device 205 are a keyboard, a mouse, and a touch panel.

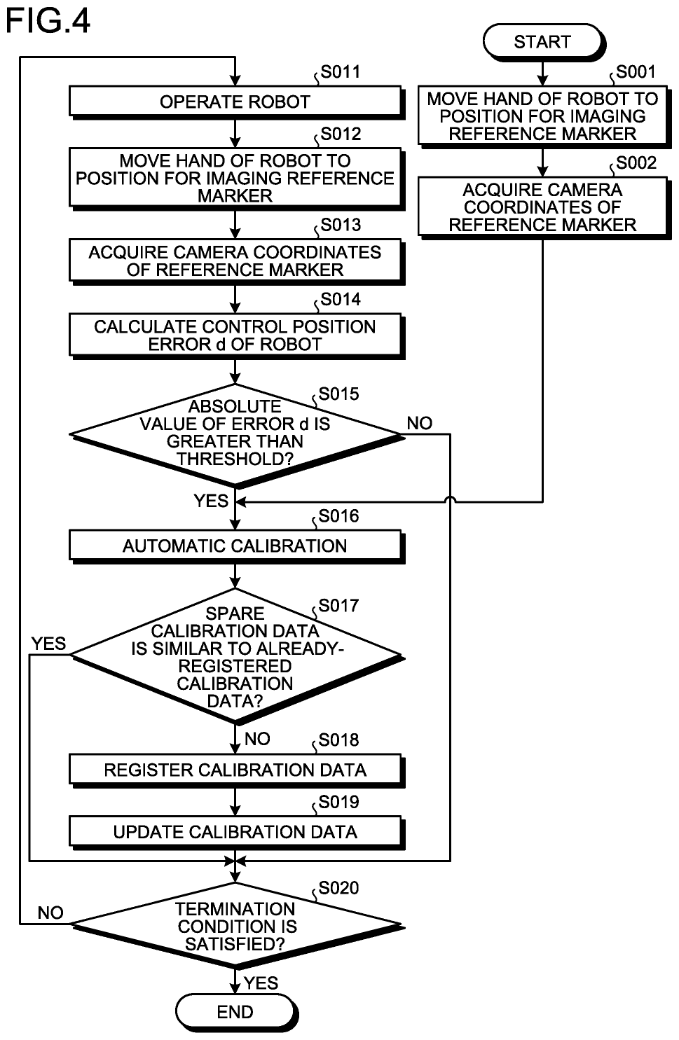

FIG. 4 is a flowchart for explaining pre-registration of calibration data according to the first embodiment. The pre-registration of calibration data is to generate calibration data and to register the calibration data in the calibration-data storing unit 26 before the actual operation of the robot 1. In the following description, a procedure for, starting from the initial state in which there is no calibration data registered, registering a plurality of pieces of calibration data is described.

First, the robot control unit 20 moves the hand of the robot 1 to the position for imaging the reference marker 5 (step S001). This movement is only required to move the robot 1 to the position at which the vision sensor 3 can image the reference marker 5. The robot control apparatus 2 stores the robot coordinates of the robot 1 after the movement as the reference robot coordinates. The robot control unit 20 controls the robot coordinates of the robot 1 so as to be the reference robot coordinates when the reference marker 5 is imaged thereafter.

Next, the vision sensor 3 images the reference marker 5 and generates image data, and the image processing unit 21 processes the image data and acquires camera coordinates vₓ of the reference marker 5 (step S002).

After step S002, the procedure proceeds to step S016 to perform automatic calibration. The automatic calibration is performed as described above, and the calibration-data calculating unit 24 calculates calibration data. This calibration data is referred to as first spare calibration data G₁. The reason the calibration data calculated by the calibration-data calculating unit 24 is referred to as spare calibration data is because the calculated calibration data cannot be registered in the calibration-data storing unit 26 in some cases, which is to be described later.

Next, the calibration-data similarity determining unit 25 determines whether the spare calibration data calculated in step S016 is similar to calibration data already registered in the calibration-data storing unit 26 (step S017). When the calibration-data similarity determining unit 25 determines that the calculated spare calibration data is similar to the calibration data already registered in the calibration-data storing unit 26 (step S017: Yes), the calculated spare calibration data is discarded, and the procedure proceeds to step S020. When the calibration-data similarity determining unit 25 determines that the calculated spare calibration data is not similar to the calibration data already registered in the calibration-data storing unit 26 (step S017: No), the procedure proceeds to step S018.

When the spare calibration data calculated in step S016 is the first spare calibration data G₁, there is no calibration data already registered in the calibration-data storing unit 26. In this case, the calibration-data similarity determining unit 25 also determines, in step S017, that the spare calibration data G₁ is not similar to the calibration data already registered in the calibration-data storing unit 26 (step S017: No), and the procedure proceeds to step S018. The similarity determination method performed by the calibration-data similarity determining unit 25 is to be described in detail later.

The robot control apparatus 2 registers, in the calibration-data storing unit 26, the spare calibration data that is determined by the calibration-data similarity determining unit 25 not to be similar to the already registered calibration data (step S018). Thus, the spare calibration data G₁ calculated in step S016 is registered in the calibration-data storing unit 26 as calibration data H₁. The calibration data H₁ is the calibration data that is first registered in the calibration-data storing unit 26, i.e., the first calibration data to be registered in the calibration-data storing unit 26. At this point in time, the camera coordinates vₓ acquired in step S002 are registered in the calibration-data storing unit 26 together with the calibration data H₁ as camera coordinates m₁ of the reference marker 5 corresponding to the calibration data H₁.

In step S019, the calibration-data updating unit 27 updates calibration data to be used by the robot control unit 20 to the calibration data H₁ registered in the calibration-data storing unit 26 in step S018. In step S019, the calibration-data updating unit 27 updates calibration data set as the calibration data to be used by the robot control unit 20 to the newly registered calibration data, that is, the last calibration data registered in the calibration-data storing unit 26. When the procedure proceeds to step S019 for the first time after the first calibration data H₁ is registered in the calibration-data storing unit 26, no calibration data to be used by the robot control unit 20 has been set, and the calibration data H₁ is thus set for the robot control unit 20.

In step S020, the termination-condition determining unit 28 determines whether a termination condition is satisfied. The termination condition includes a condition that the total of the operation time of the robot 1 in step S011 (to be described later) performed a plurality of times exceeds the time assumed in actual operation and a condition that registration of a predetermined number of pieces of calibration data in the calibration-data storing unit 26 is completed; however, the termination condition may be a condition that any one of a plurality of conditions is satisfied. The reason why the condition that the total of the operation time of the robot 1 in step S011 exceeds the time assumed in actual operation is used as the termination condition is that, when this condition is satisfied, it is assumed that the acquisition of calibration data in the environment according to actual operation is completed. In addition, the reason why the condition that registration of a predetermined number of pieces of calibration data in the calibration-data storing unit 26 is completed is used as the termination condition is that, when this condition is satisfied, it is possible to determine that the necessary diversity of the registered calibration data is ensured. Thus, when the termination-condition determining unit 28 determines that the termination condition is satisfied (step S020: Yes), the procedure is terminated.

However, when the procedure proceeds from step S001 to step S020 for the first time, step S011 has not been performed and only one piece of calibration data is registered in the calibration-data storing unit 26. Thus, the termination-condition determining unit 28 determines that the termination condition is not satisfied (step S020: No), and the procedure proceeds to step S011.

In step S011, the robot control unit 20 causes the robot 1 to perform the same operation as the actual operation. The operation of the robot 1 in step S011 is operation to be performed by the robot 1 in prior confirmation of the operation, such as a continuous operation test, and the pre-registration of calibration data in FIG. 4 can be performed in addition to the prior confirmation of the operation, such as a continuous operation test.

When the predetermined operation of the robot 1 in step S011 is terminated, the robot control unit 20 moves the hand of the robot 1 to the position for imaging the reference marker 5 (step S012). At this point in time, the robot control unit 20 controls the robot coordinates of the robot 1 so as to be the reference robot coordinates stored in step S001.

Next, the vision sensor 3 images the reference marker 5 and generates image data, and the image processing unit 21 processes the image data and acquires the camera coordinates vₓ of the reference marker 5 (step S013). When the camera coordinates vₓ acquired at this point in time are different from the camera coordinates vₓ acquired in step S002 or the previous step S013, this is caused by the mechanism error due to a change over time, such as thermal drift when the robot 1 is operated.

Then, the error calculating unit 22 calculates a control position error d of the robot 1 (step S014). Specifically, the calculation is performed based on the following Formula (1).

d=Hᵢ(vₓ−mᵢ) i=1, . . . ,n (1)

where, vₓ, mᵢ, and d are vectors, and Hᵢ is a matrix.

In Formula (1), Hᵢ is the calibration data currently used by the robot control unit 20, and mᵢ is the camera coordinates of the reference marker 5 corresponding to the calibration data Hᵢ. Thus, (vₓ−mᵢ) is an error vector in the camera coordinates indicating the shift of the current camera coordinates vₓ of the reference marker 5 imaged in a state where the robot 1 is controlled so as to be at the reference robot coordinates from the camera coordinates mᵢ of the reference marker 5 corresponding to the currently used calibration data H₁. By multiplying the calibration data Hᵢ by (vₓ−mᵢ), the control position error d, which is an error vector in the robot coordinates, is obtained.

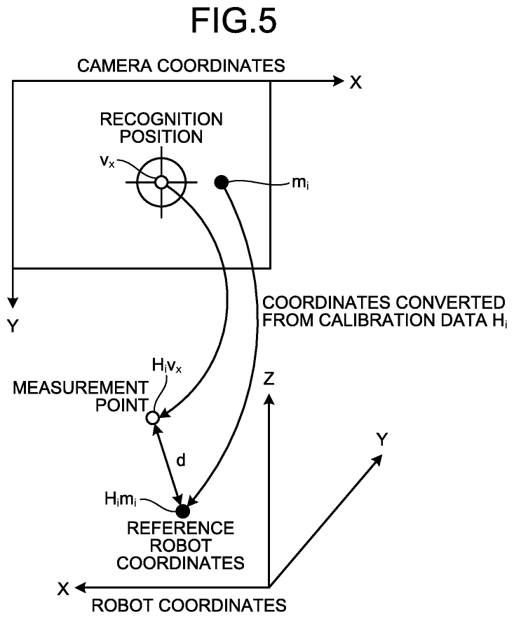

FIG. 5 is a diagram for explaining a relation between an error in camera coordinates and an error in robot coordinates in the first embodiment. In the camera coordinates in FIG. 5, the current recognition position of the reference marker 5 is illustrated at the camera coordinates vₓ. The camera coordinates mᵢ of the reference marker 5 corresponding to the calibration data Hᵢ currently set for the robot control unit 20 and used are also illustrated in the camera coordinates in FIG. 5. The shift of the camera coordinates vₓ from the camera coordinates mᵢ is caused by a mechanism error due to a change over time, such as thermal drift when the robot 1 is operated, as described above. Then, Hᵢvₓ, which is the first term when the parentheses on the right side of Formula (1) are removed, is a measurement point corresponding to the current camera coordinates vₓ in the robot coordinates. In addition, Hᵢmᵢ, which is the second term when the parentheses on the right side of Formula (1) are removed, is the fixed coordinates in the robot coordinates determined based on the installation position of the reference marker 5, and this is the reference robot coordinates. The fixed coordinates of Hᵢmᵢ indicates that the calibration data Hᵢ needs to be changed as the camera coordinates mᵢ of the reference marker 5 move. The shift of Hᵢvₓ from Hᵢmᵢ is the control position error d, which is the error vector in robot coordinates.

When the procedure proceeds to step S014 for the first time, the calibration data currently used by the robot control unit 20 is H₁, and the camera coordinates of the reference marker 5 corresponding to the calibration data H₁ are m₁. Thus, Formula (1) is d=H₁(vₓ−m₁).

After the control position error d of the robot 1 is calculated in step S014, the error determining unit 23 determines whether the absolute value of the error d is greater than a predetermined threshold (step S015). When the error determining unit 23 determines that the absolute value of the error d is equal to or less than the threshold (step S015: No), the procedure proceeds to step S020.

When the error determining unit 23 determines that the absolute value of the error d is greater than the predetermined threshold (step S015: Yes), the procedure proceeds to step S016 to perform the automatic calibration. In step S016, the new calibration data calculated by the calibration-data calculating unit 24 is set as spare calibration data G₂.

Next, the calibration-data similarity determining unit 25 determines, in step S017, whether the spare calibration data G₂ calculated in step S016 is similar to the calibration data already registered in the calibration-data storing unit 26 (step S017). Only the calibration data H₁ is currently registered in the calibration-data storing unit 26. Thus, when the calibration-data similarity determining unit 25 determines that the spare calibration data G₂ is similar to the calibration data H₁ (step S017: Yes), the spare calibration data G₂ is discarded, and the procedure proceeds to step S020. When the calibration-data similarity determining unit 25 determines that the spare calibration data G₂ is not similar to the calibration data H₁ (step S017: No), the procedure proceeds to step S018, and the spare calibration data G₂ is registered in the calibration-data storing unit 26 as calibration data H₂.

A description will be given below of an example of a determination method by which the calibration-data similarity determining unit 25 determines, in step S017, whether the spare calibration data G₂ is similar to the registered calibration data H₁. First, the elements of the spare calibration data G₂, which is a matrix, are arranged in order, and the thereby-obtained vector whose norm is 1 is set as g₂. Next, the elements of the calibration data H₁, which is also a matrix, are arranged in the same order as when g₂ was created, and the thereby-obtained vector whose norm is 1 is set as h₁. Then, the inner product of g₂ and h₁ is calculated and compared with a determined value. When the inner product of g₂ and h₁ is equal to or greater than the determined value, the calibration-data similarity determining unit 25 determines that the spare calibration data G₂ is similar to the calibration data H₁ (step S017: Yes). In contrast, when the inner product of g₂ and h₁ is less than the determined value, the calibration-data similarity determining unit 25 determines that the spare calibration data G₂ is not similar to the calibration data H₁ (step S017: No).

After the spare calibration data G₂ is registered in the calibration-data storing unit 26 as the calibration data H₂ in step S018, the procedure proceeds to step S019.

In step S019, the calibration-data updating unit 27 updates the calibration data H₁ set as the calibration data to be used by the robot control unit 20 to the calibration data H₂ newly registered in the calibration-data storing unit 26. Then, the procedure proceeds to step S020.

The flowchart illustrated in FIG. 4 is executed and the step S018 is repeatedly executed in this manner, whereby, the calibration data H₁, H₂, . . . , and Hₙ are preregistered in the calibration-data storing unit 26. The calibration data H₁, H₂, . . . , and Hₙ are n number of calibration data having diversity under the condition that a change over time in the actual operation environment of the robot 1 is taken into consideration. The camera coordinates m₁, m₂, . . . , and mₙ of the reference marker 5 respectively corresponding to the calibration data H₁, H₂, . . . , and Hₙ are also registered in the calibration-data storing unit 26.

As described above, under an environment in which a mechanism error over time, such as thermal drift when the robot 1 is operated for a long time, occurs, it is possible for the robot control apparatus 2 according to the first embodiment to register, in the calibration-data storing unit 26, a plurality of pieces of calibration data that take into account the mechanism error. The plurality of pieces of calibration data are used by the robot control unit 20, and it is thereby possible to improve the accuracy of the operation position of the robot 1 by correcting the mechanism error even when the robot 1 is deformed over time.

The robot control unit 20 may use the plurality of pieces of registered calibration data in the order of the registration in the calibration-data storing unit 26. In addition, the robot control unit 20 may use the plurality of pieces of registered calibration data according to the time intervals registered in the calibration-data storing unit 26. Furthermore, the robot control unit 20 may use the plurality of pieces of registered calibration data according to a method to be described later in a second embodiment. With any method, it is expected that the accuracy of the operation position of the robot 1 can be improved by correcting the mechanism error even when the robot 1 is deformed over time.

Note that, the flowchart illustrated in FIG. 4 can be executed by adding the description for executing processing other than step S011 in FIG. 4 to the operation program that causes the robot 1 to execute the processing in step S011.

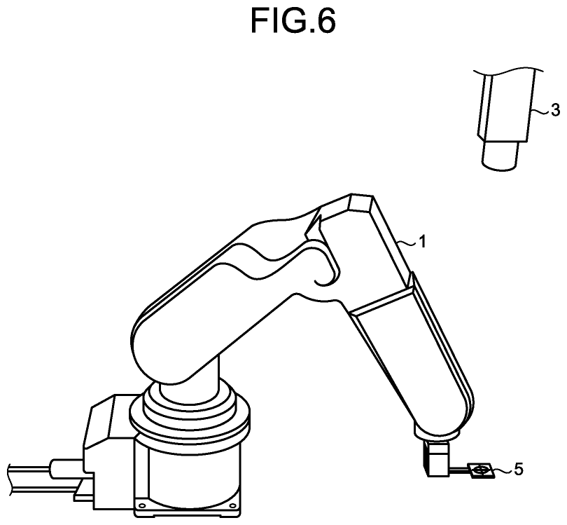

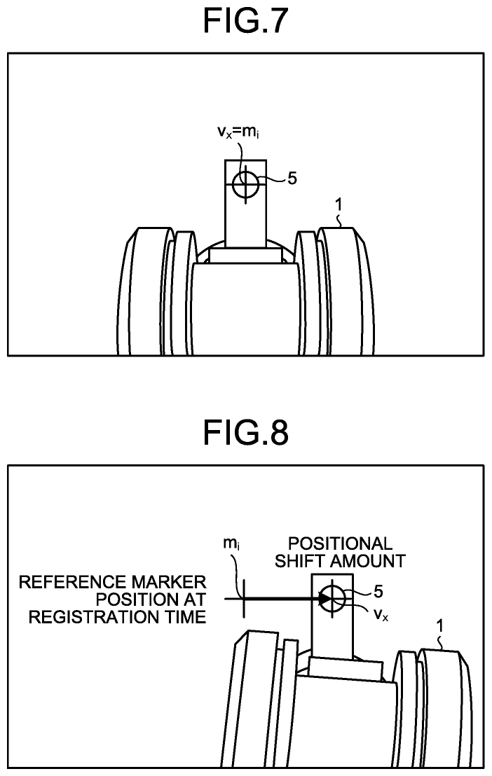

FIGS. 1 and 2 each illustrate an example of the hand-eye method in which the vision sensor 3 is attached to the hand of the robot 1, but the installation method of the vision sensor 3 is not limited thereto. FIG. 6 is a perspective view illustrating another configuration including the robot 1, the vision sensor 3, and the reference marker 5 according to the first embodiment. FIG. 7 is a view illustrating an imaging screen displaying the reference marker 5 using a fixing method according to the first embodiment. FIG. 8 is another view illustrating the imaging screen displaying the reference marker 5 using the fixing method according to the first embodiment.

As illustrated in FIG. 6, it is possible to use a fixing method, in which the vision sensor 3 is fixed so as not to move in the space where the robot 1 is installed, and the reference marker 5 is attached to the hand of the robot 1. Note that, the vision sensor 3 is connected to the robot control apparatus 2, which is not illustrated in FIG. 6.

FIG. 7 illustrates that the camera coordinates vₓ of the reference marker 5, that is, the camera coordinates mᵢ, are acquired in step S002 in FIG. 4 and in step S013 when the calibration data is to be registered. FIG. 8 illustrates that the camera coordinates vₓ of the reference marker 5 are acquired after the camera coordinates mᵢ are acquired as illustrated in FIG. 7, the step S011 is repeated several times, and the robot 1 undergoes a change over time, such as thermal drift. As illustrated in FIG. 8, the camera coordinates vₓ are moved from the camera coordinates mᵢ due to the change over time.

In this manner, in the case of using the fixing method, the flowchart of FIG. 4 can be executed in the same manner as in the case of using the hand-eye method, and it is possible to pre-register the calibration data H₁, H₂, . . . , and Hₙ in the calibration-data storing unit 26. As a method of configuring the vision sensor 3, a configuration method other than the hand-eye method and the fixing method may be used as long as the flowchart of FIG. 4 can be executed.

### Second Embodiment

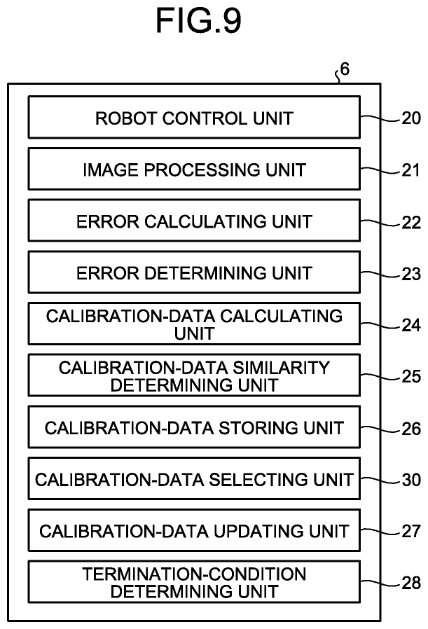

FIG. 9 is a diagram illustrating a configuration of a robot control apparatus 6 according to a second embodiment of the present invention. In the robot control apparatus 6, a calibration-data selecting unit 30 is added to the robot control apparatus 2 in FIG. 1. The functions of the elements other than the calibration-data selecting unit 30 of the robot control apparatus 6 are the same as those of the elements denoted by the same reference signs in the robot control apparatus 2. A robot control system according to the second embodiment has a configuration in which the robot control apparatus 2 in FIG. 1 is replaced by the robot control apparatus 6. The vision sensor 3 may be configured by the hand-eye method in FIGS. 1 and 2, the fixing method in FIG. 6, or other methods.

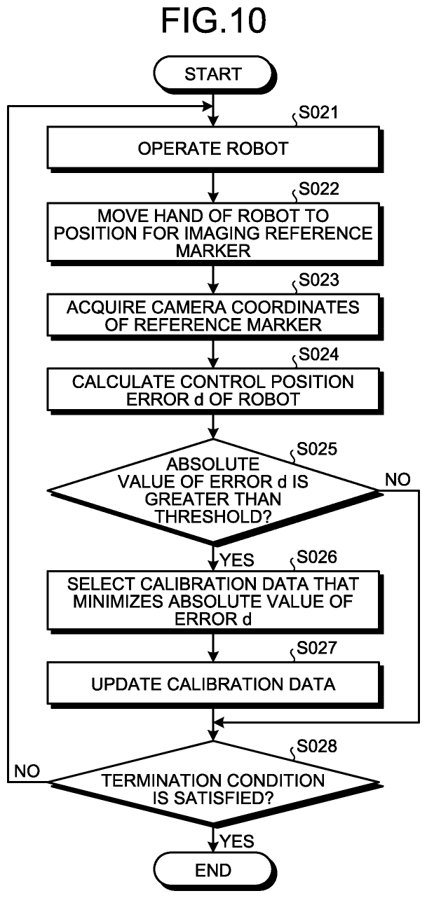

FIG. 10 is a flowchart at the time of actual operation of the robot control system using calibration data according to the second embodiment. Before the flowchart of FIG. 10 is started, it is assumed that a plurality of pieces of calibration data H₁, H₂, . . . , and Hₙ are pre-registered in the calibration-data storing unit 26 as described in the first embodiment. As the calibration data to be used, one piece of calibration data Hₖ selected from the calibration data H₁, H₂, . . . , and Hₙ has been set for the robot control unit 20. When it is believed that a change over time, such as thermal drift, has not occurred at the time of starting the actual operation of the robot 1, the calibration data H₁ may be selected as the calibration data Hₖ initially set for the robot control unit 20, but any calibration data may be selected as long as it is selected from the calibration data H₁, H₂, . . . , and Hₙ.

First, the robot control unit 20 causes the robot 1 to operate to execute predetermined work (step S021). In step S011 in FIG. 4, the operation in step S021 is performed.

Next, the robot control unit 20 moves the hand of the robot 1 to the position for imaging the reference marker 5 (step S022). At this point in time, the robot control unit 20 controls the robot 1 to be at the reference robot coordinates stored in step S001 in FIG. 4.

Next, the vision sensor 3 images the reference marker 5 and generates image data, and the image processing unit 21 processes the image data and acquires the camera coordinates vₓ of the reference marker 5 (step S023).

Then, the error calculating unit 22 calculates the control position error d of the robot 1 (step S024). The control position error d is calculated using Formula (1) used in the description of step S014 in the first embodiment. Thus, the control position error d obtained by executing step S024 for the first time is expressed by d=Hₖ(vₓ−mₖ).

After the control position error d of the robot 1 is calculated in step S024, the error determining unit 23 determines whether the absolute value of the error d is greater than a predetermined threshold (step S025). When the error determining unit 23 determines that the absolute value of the error d is equal to or less than the threshold (step S025: No), the procedure proceeds to step S028.

When the error determining unit 23 determines that the absolute value of the error d is greater than the predetermined threshold (step S025: Yes), the procedure proceeds to step S026, and the calibration-data selecting unit 30 selects, from the calibration-data storing unit 26, the calibration data that minimizes the absolute value of the error d. Specifically, the error d is calculated by substituting each piece of the calibration data H₁, H₂, . . . , and Hₙ registered in the calibration-data storing unit 26 into Formula (1), and the calibration-data selecting unit 30 selects the calibration data that minimizes the absolute value of the error d.

Then, the calibration-data updating unit 27 updates the calibration data set as the calibration data to be used by the robot control unit 20 to the calibration data selected in step S026 (step S027). Thus, when step S026 is executed for the first time, the calibration data Hₖ set as the calibration data to be used by the robot control unit 20 is updated to the calibration data H₁ selected in step S026.

In step S028, the termination-condition determining unit 28 determines whether a termination condition is satisfied. The termination condition is the termination condition in the actual operation of the robot 1. Thus, when the termination-condition determining unit 28 determines that the termination condition is satisfied (step S028: Yes), the procedure is terminated. When the termination-condition determining unit 28 determines that the termination condition is not satisfied (step S028: No), the procedure returns to step S021 to operate the robot 1.

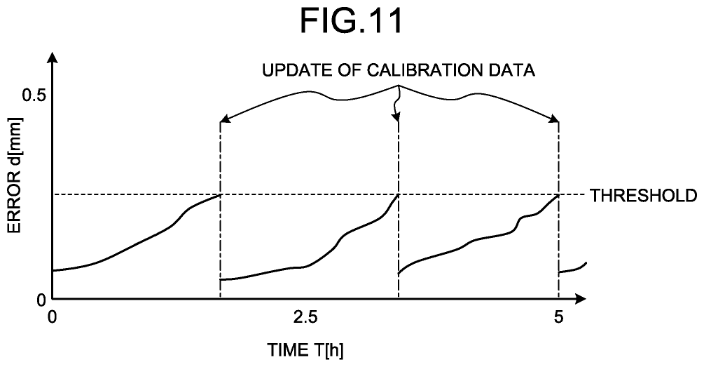

FIG. 11 is a diagram for explaining temporal variation in the error d in the second embodiment. FIG. 11 illustrates that the error d increases with time due to the mechanical error caused by the change of the robot 1 over time, but decreases such that it does not to exceed the threshold each time the calibration data to be used by the robot control unit 20 is updated in step S027.

As described above, with the robot control apparatus 6 according to the second embodiment, it is possible to eliminate the time required to acquire the calibration data corresponding to a mechanism error over time during the operation of the robot 1, and it is possible to efficiently operate the robot 1 while appropriately correcting the mechanism error over time.

The configurations described in the above embodiments are merely examples of an aspect of the present invention and can be combined with other known techniques, and part of the configurations can be omitted or changed without departing from the gist of the present invention.

### REFERENCE SIGNS LIST

1 robot; 2, 6 robot control apparatus; 3 vision sensor; 4 workbench; 5 reference marker; 20 robot control unit; 21 image processing unit; 22 error calculating unit; 23 error determining unit; 24 calibration-data calculating unit; 25 calibration-data similarity determining unit; 26 calibration-data storing unit; 27 calibration-data updating unit; 28 termination-condition determining unit; 30 calibration-data selecting unit; 100 robot control system; 201 CPU; 202 memory; 203 storage; 204 display; 205 input device.

1. A robot control apparatus comprising:
robot control circuitry to control operation of a robot using calibration data;
image processing circuitry to acquire camera coordinates of a reference marker from image data acquired by a vision sensor;
error calculating circuitry to calculate an error on a basis of a difference between camera coordinates of the reference marker corresponding to the calibration data and current camera coordinates of the reference marker;
calibration-data calculating circuitry to calculate new calibration data when an absolute value of the error becomes greater than a threshold; and
a calibration-data memory to register the new calibration data,
wherein the robot control apparatus causes the calibration-data calculating circuitry to calculate the new calibration data a plurality of times while causing the robot to operate between the calculations and causes the calibration-data memory to register a plurality of pieces of the new calibration data.

2. The robot control apparatus according to claim 1, wherein the robot control apparatus causes the calibration-data memory to register the new calibration data that is not similar to the calibration data registered in the calibration-data memory.

3. The robot control apparatus according to claim 1, further comprising:
calibration-data selecting circuitry to select, from the pieces of calibration data registered in the calibration-data memory, calibration data that minimizes the absolute value of the error when the absolute value of the error becomes greater than a threshold,
wherein the robot control circuitry uses the calibration data selected by the calibration-data selecting circuitry.

4. The robot control apparatus according to claim 1, wherein the vision sensor is included in the robot.

5. The robot control apparatus according to claim 1, wherein the vision sensor is fixed against movement.

6. A calibration method comprising:
operating a robot using calibration data;
acquiring camera coordinates of a reference marker from image data acquired by a vision sensor;
calculating an error on a basis of a difference between camera coordinates of the reference marker corresponding to the calibration data and current camera coordinates of the reference marker;
calculating new calibration data when an absolute value of the error becomes greater than a threshold; and
registering the new calibration data,
wherein the calculating new calibration data comprises calculating the new calibration data a plurality of times while performing the operating between the calculations to register a plurality of pieces of the new calibration data in the registering.

7. The robot control apparatus according to claim 2, further comprising:
calibration-data selection circuitry to select, from the pieces of calibration data registered in the calibration-data memory, calibration data that minimizes the absolute value of the error when the absolute value of the error becomes greater than a threshold,
wherein the robot control circuitry uses the calibration data selected by the calibration-data selecting circuitry.

8. The robot control apparatus according to claim 2, wherein the vision sensor is included in the robot.

9. The robot control apparatus according to claim 3, wherein the vision sensor is included in the robot.

10. The robot control apparatus according to claim 7, wherein the vision sensor is included in the robot.

11. The robot control apparatus according to claim 2, wherein the vision sensor is fixed against movement.

12. The robot control apparatus according to claim 3, wherein the vision sensor is fixed against movement.

13. The robot control apparatus according to claim 7, wherein the vision sensor is fixed against movement.
